(19) United States
(12) Patent Application Publication
(10) Pub. No.: US 2006/0179150 A1
(43) Pub. Date: Aug. 10, 2006

(54) Client server model

(76) Inventors: Patrick B Farley, Ipswich (GB); Martin J. Yates, Ipswich (GB); Michael R Hosking, Ipswich (GB); Femi Ayoola, Ipswich (GB); David Roxburgh, Ipswich (GB); Simon A Beddus, Ipswich (GB)

Correspondence Address: NIXON & VANDERHYE, PC, 901 NORTH GLEBE ROAD, 11TH FLOOR, ARLINGTON, VA, 22203, US

(21) Appl. No.: 10/549,358

(22) PCT Filed: Mar. 12, 2004
(86) PCT No.: PCT/GB04/01061

§ 371 Date: Sep. 14, 2005

(30) Foreign Application Priority Data
Mar. 26, 2003 (GB) 0306971.3

(51) Int. Cl. G06F 15/16

(52) U.S. Cl. 709/228

(57) ABSTRACT

A client-side intermediary (30) is provided to balance the loading of Web service requests between a plurality of servers (32). The status of the Web service servers (32) is monitored by a monitoring server (35) which provides status updates to the intermediary (30) upon request. The intermediary then uses the information on the status of the servers (32) to decide where to send web service requests. Additionally, the intermediary is able to direct requests for Web service descriptions to the least busy server on the basis of status information. The intermediary (30) substitutes its own identifier for the service name and port in the Web service description before passing it to the client so that all requests are directed through it, thus allowing the continual provision of service for the client even in the event that one of the servers fails.

This invention relates to an improved client server model, in particular to a system comprising a client module and several server modules, and to a method for managing service requests between the client and server modules. The invention is particularly applicable in the area of high availability Web services.

Web services are a form of distributed computing, in which one device (a client) calls procedures provided on another device (server) so as to use the sevices provided by that server. There are a number of different distributed computing applications in which various different protocols are used such as CORBA and DCOM. Distributed systems may use a variety of different means for the client to call the procedure on the server, such as remote method in vocation (RMI), remote procedure calling (RPC) or message queuing.

Web services can be considered as a collection of functions which have been packaged together and published to a network for use by clients within the network. They provide the building blocks for creating open distributed systems, and as such any number of Web services can be combined to form more complicated, higher level service. Today, Web services are used to enable communication between computers in the form of messaging and RPC mechanisms across IP networks. Essentially, the advantages of Web services over other distributed computing arrangements are that they are particularly suited for heterogeneous environments such as the internet. The reason for this is that the Web services use an XML-based communication protocol which is light weight and easily understandable by all of the various different Web services. In addition, the Web services operate by transmitting communication messages using any underlying network communication protocols, but in particular use HTTP which is ubiquitous throughout the internet. The advantages of Web services in the use of HTTP transport and XML encoding which are supported by many computing platforms such as Java and Microsoft. One example of a Web service is Microsoft passport (an authentication service hosted by Microsoft).

The protocol stack for Web services comprises, at the top, the Web services applications which are offered by service providers for access by a service requester (client). Under this, the XML-based communication mechanism mentioned earlier is typically SOAP (Simple Object Access Protocol)—this XML-based standard is a messaging framework designed for exchanging structured information in a distributed environment over a variety of underlying protocols, but is lightweight in that it misses out many advanced features such as reliability, security, and routing. The XML-bassed messaging protocol operates over the underlying network communication protocols (eg HTTP). These features of Web services mean that they provide one of the best interfaces for interoperability between legacy systems, Java and .Net systems. Unfortunately, they do suffer from some limitations, in particular load balancing and load sharing cannot be supported in the normal way.

Earlier British Telecommunications patent application PCT/GB02/03981 is directed towards a system which overcomes some of the limitations encountered in distributed computing. In particular, the system address the problems which can arise between a client-sever relationship when one or more clients overuse the capabilities of the servers, and solve these using the compulsory download of a client side intermediary which acts to control the call rates allowed to the server. This thereby prevents the server from overuse by throttling back the call rate in the event that the server becomes congested, and offering better load control of the services offered by the servers. However, this system is directed towards a single client-sever relationship, and as such does not address the problems encountered in a multi-sever environment of high availability Web services, in which duplicate Web services are operated on several different servers. In particular, the failover capability should one of the servers or Web services fail is not addressed.

Whilst, in theory, re-routing to an alternative server in the event of failure can be performed in the system using known methods, these do not address the particular issues associated with Web service as outlined below.

The provision of a Web service is summarised as follows: In order that a Web service can be utilised, the Web service provider needs to make publicly available details of the Web service applications, together with the formats, protocols etc. necessary to access the service and communicate with the Web service server. This is achieved using a WSDL (Web Service Description Language) service description, which provides a specification of the service, describing the location and interfaces used in Web services exchanges. The WSDL is downloaded by the client, which thereby has the information it requires in order to access the service. Information provided by WSDL's includes services available, message formats and port numbers which should be used when accessing services.

The client is able to decide which Web services are required, to create the required XML-messages (using SOAP) which will invoke the Web service operation from the Web service server. These messages are presented together with the address of the service provider to a SOAP run time which interacts with an underlying network protocol (HTTP) to send a SOAP message over the network. The message is then delivered by the network to the Web service SOAP server, where the XML message is translated into the specific programming language relevant for the application. Finally, the Web service server produces a response in a form of a SOAP message which is sent back to the requesting client.

The particular problems with this procedure arise when the server becomes unavailable, since the “binding” which enables the client to direct the messages to the server is still in place, and the client will suffer failed responses. The “binding” occurs as follows. The WSDL received by the client (which is used when generating the SOAP messages for accessing the Web service) additionally provides the service name (URI) and service port (URN). The URN and URI are combined together by the client, to make a uniform resource locator (URL), i.e.: “http://www.ericaserver.bt.co.uk”+“/WebService1”=“http://www.ericaserver.bt.co.uk/WebService1” The client DNS (Domain Name Service) translates the URL into an IP address, and then the SOAP message is sent to the relevant destination Web service server, which is listening on the specific port for the incoming messages.

This procedure of “binding”, linking the WSDL to URL and then to IP address, is maintained thoughout the lifecycle of the client, unless the client specifically demands a re-bind. In this case, all further calls to the service are performed without reference again to the WSDL. If the server becomes congested or fails then the client only notices when it tries to send a SOAP message to the server and the process eventually fails. In this case, if the WSDL has multiple service names and ports specified, then the client can attempt to rebind to another one. However, even if achieved this will have caused a disruption to the service offered to the client. In addition, if the client has not been programmed to cater for such a condition, then the client will fail. In addition to the problems encountered during failure of a server, no distribution of loading is carried out since the client will only send SOAP requests to one server (service port) unless the client is forced to rebind before it sends every message. However, such dynamic rebinding would require special programming by the client and in some cases the Web services SDK (software development kit) supplied with .Net or Java may not support It. In some cases, Web service bindings may last for longer than the planned SOAP server uptime, thus when a server is taken down for maintenance the client will suffer failed responses.

Attempts to address this problem include a method known as the “DNS round robin method” in which multiple services IP addresses are registered to the same DNS entry. However, this is flawed because dynamic rebinding to the next IP address is not guaranteed. In addition, this method only works at the IP level, and not at the service name or port level.

The present invention seeks to mitigate the disadvantages of the prior art.

According to a first aspect of the present invention, there is provided a method of managing service requests from a first module acting as a client module, to a plurality of other modules acting as server modules, the method comprising:

an information-collating module receiving from each of the other modules an indication of the operational status of each of the other modules;

at the first module, a control intermediary receiving from the information-collating module an indication of the operational status of each of the other modules;

the control intermediary selecting one of the other modules for directing a service request to based on the indications of operational status of the other modules.

According to a second aspect of the present invention, there is provided a method of managing service requests from a first module acting as a client module, to a plurality of other modules acting as server modules, the first module comprising a client application and a control intermediary, the method comprising:
an information-collating module receiving from each of the other modules an indication of the operational status of each of the other modules;
the control intermediary receiving from the information-collating module an indication of the operational status of each of the other modules;

the control intermediary receiving a request for a Web service description from the client application, and selecting one of the other modules to direct the request to based on the indications of operational status of the other modules;

the control intermediary receiving the requested Web service description and substituting an identifier of the control intermediary into the description before passing the description to the client application.

According to a third aspect of the present invention, there is provided a system comprising a first module acting as a client module and a plurality of other modules acting as server modules, in which the client module is arranged to send service requests to the other modules, the system further comprising:

an information-collating module arranged to receive from each of the other modules an indication of the operational status of the other modules; and

the client module comprising a control intermediary arranged to receive from the information-collating module an indication of the operational status of each of the other modules, and further arranged to select one of the other modules for directing a service request to based on the indications of operational status of the other modules.

According to a fourth aspect of the present invention, there is provided a system comprising a first module acting as a client module and a plurality of other modules acting as server modules, the first module comprising a client application and a control intermediary, in which the client module is arranged to send service requests to the other modules, the system further comprising:

an information-collating module arranged to receive from each of the other modules an indication of the operational status of the other modules;

the control intermediary arranged to receive from the information-collating module an indication of the operational status of each of the other modules;

the control intermediary further arranged to receive a request for a Web service description from the client application, and to select one of the other modules for directing a service request to based on the indications of operational status of the other modules; and

the control intermediary arranged to receive the requested Web service description and substitute an identifier of the control intermediary into the description before passing the description to the client application.

Specific embodiments according to the invention will now be described, by way of example, with reference to the accompanying drawings, in which:

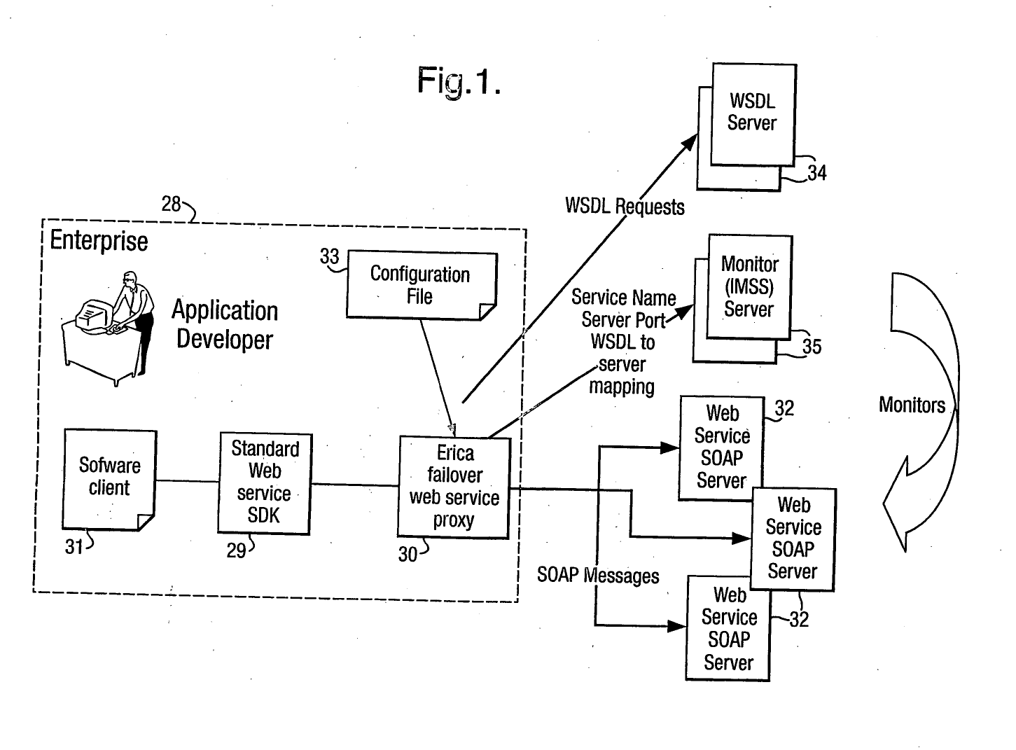

FIG. 1 shows a schematic of a system according to the invention;

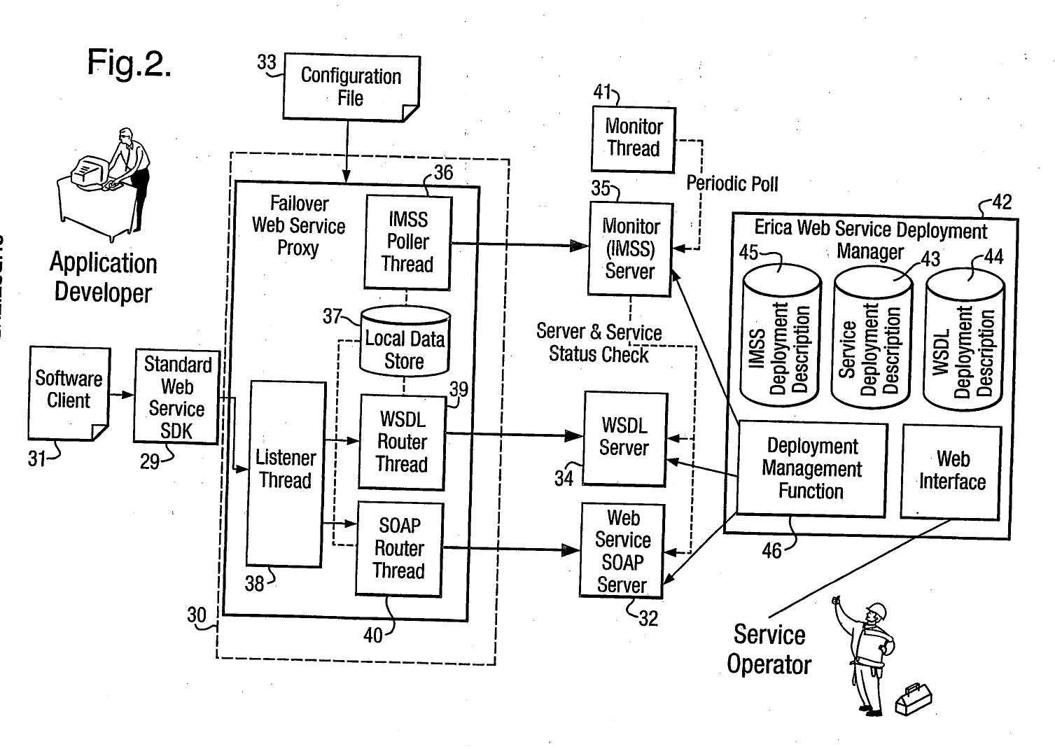

FIG. 2 shows a the system of FIG. 1 in more detail; and

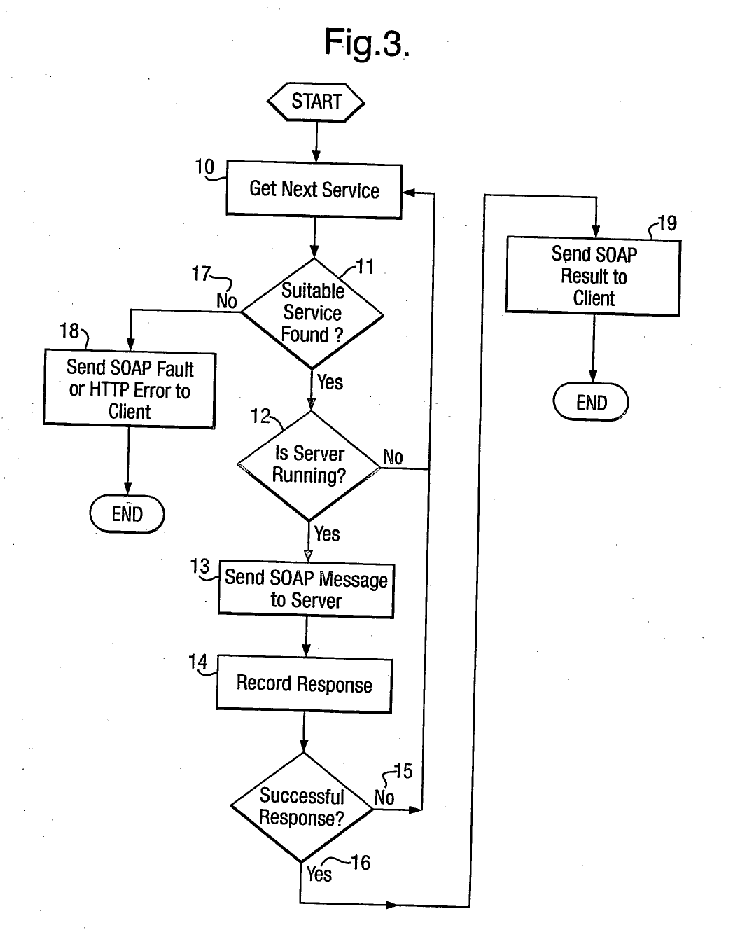

FIG. 3 shows a method of handling Web service requests within the system of FIG. 1.

Referring to FIG. 1, there is shown a system according to an embodiment of the invention. The system comprises a plurality of Web service servers 32 on which are running various applications which provide service capabilities which a software client 31 requires. The system also comprises Web service proxy 30, a client side component, which acts as an intermediary for messages passing between client 31 and Web service servers 32. The system further comprises a plurality of monitoring servers 35 which monitor the operational status of the Web service servers 32, and which also transmit this information upon request to the proxy 30. Additionallly, the system comprises a plurality of WSDL servers 34 which provide upon request WSDL service specifications detailing the Web services available on the Web service servers 32. The client side components further include software development kit 29, and a configuration file 33 for use by the proxy when communicating with the servers 34, 32, 35.

In operation, a service specification (WSDL) request is generated by client 31, and routed via the proxy 30 to one of the WSDL servers 34. The response, the WSDL, is then transmitted back from the WSDL server 34 via the proxy 30 to the client 31, where it is used to generate the necessary service request messages for accessing the Web service capabilities provided by servers 32. These service request messages also, and successful responses, are also routed via the proxy 31. Essentially, the proxy 30 acts as a distribution point though which all requests for WSDL and all service request messages are passed.

The proxy 30, upon receipt of a request (either a WSDL request or a Web service request message) from the client 31 will select which server to forward the request to on the basis of the current operational status of the servers. For example, the proxy 30 will forward a WSDL request to an appropriate WSDL server which is available and lightly loaded. Upon successfully retrieving the WSDL from the WSDL server 34, the proxy 30 parses the WSDL, replacing the service name and port to point instead to the address of the proxy 30, before passing it back to the client 31

When the client receives the WSDL it is able to use it to automatically create the necessary helper classes or to hand build the necessary Web service requests (SOAP messages) for utilising the Web service. These SOAP messages are then directed through the proxy 30, which again decides which Web service server 32 to forward the request to. If no response is received from the selected Web service server by the proxy 30, it will record that the selected Web service server 32 has failed, and send the request to an alternative Web service server 32. This step will be repeated as necessary until a successful response to the request is received by the proxy 30, which it then forwards to the client 31. In this manner, the client 31 uses the proxy 30 transparently, and will be completely unaware of any re-routing, load sharing and load balancing which is being carried out.

In order to decide where to route the messages, the proxy 30 communicates with a plurality of Monitoring servers 35, whose details are stored in configuration file 33. The proxy 30 receives information about the status of WSDL servers 34 and Web service servers 32 from the Monitoring servers 35, via use of a SOAP based or HTTP GET-RESPONSE polling mechanism to draw the information from the Monitoring servers 35. Monitoring servers 35 provide load information, server availability, and lists of which WSDLs and service names are available on particular servers. This information may be supplemented by more detailed status information on individual server load and status (eg server shutting down in five minutes, server out of service). In this manner the proxy 30 frequently updates itself on the status and availability of the servers, allowing it to both balance the loading of the servers efficiently, and also to accurately select an appropriate alternative server to re-route messages to in the event of a particular server failing.

In addition, the proxy 30 monitors the performance of the Web service servers 32 and WSDL servers 34 itself through the speed of response to requests, thus receiving a good indication of network latency and server performance so as to provide the best performance to the client 31 by redirecting the requests as necessary. It is envisaged that server and client side components might be geographically widely dispersed, such as for example, locating the client side compents on the US East coast, with the proxy operating so as to pull the WSDL off a server located on the US West coast, and then subsequently routing SOAP messages to a server farm in the UK.

The system is now described in more detail with reference to FIG. 2 and the flow chart of FIG. 3. In particular, the proxy 30 comprises poller thread 36 and local data store 37. The proxy 30, when started, performs a status check on the servers and Web services by polling the Monitoring servers 35 under its jurisdiction using the poller thread 36. Configuration file 33, as well as providing details pointing to the Monitoring servers 35 also holds authentication details for connecting to the Monitoring servers. When poller thread 36 polls the Monitoring servers 35, security principles and credentials are supplied to allow access and also so that the Monitoring server can identify the proxy 30 and provide customised information if necessary.

The information received by proxy 30 from each Monitoring server 35 may include indications of loading of servers 32, 34, Web service availability, lists of what WSDLs, service names are available on particular servers, and also information on the other Monitoring servers 35. The received information are written into the local data store 37 in the form of service records, WSDL records and Monitoring server records, such as some examples included in Appendix A:

Proxy 30 further comprises a listener thread 38, WSDL router thread 39 and SOAP router thread 40. When a WSDL request sent from client 31 arrives at the proxy 30, it is recognised by the listener thread 38 and guided to the WSDL router 39. The WSDL router 39 takes the service name URI (Uniform Resource Indicator) eg “webservice1” and performs a lookup on the local-data store 37 to find an appropriate WSDL server. If one is found a URL is constructed by the WSDL router 39, and the request forwarded to the selected WSDL server. If no response is received, local data store 37 is updated, another WSDL server selected and the request resent.

Only after all the WSDL servers have been tried are all the options are exhausted, and the client is notified through HTTP 401 error. The lack of success is recorded in the local data store 37 as a negative number, i.e. HTTP 404 becomes −404. In most cases, the WSDL will be retrieved successfully by the WSDL router 39, and the response time and success are recorded in the local data store 37. The WSDL is then parsed and the name and service port changed so as to point to the address of the proxy 30. The WSDL is passed back to the client 31.

The client can then use the WSDL to automatically create the necessary helper classes or to hand build the SOAP messages for utilising the Web service. The SOAP messages are then sent to the proxy 30, where they are received by the listener thread 38 and guided to the SOAP router 40. The SOAP router performs a lookup (step 10) on the local data store 37 using the service name URI (eg “webservice1”) to find an appropriate Web service SOAP server 32 (steps 11 and 12) chosen, for example based on previous success, performance and current load.

For example, the Web service server may be selected based on pre-defined selection criteria, such as:

load share—the load is shared across a set of servers based on the “round robin” principle

load balance—the load is sent to the least busy server

past performance—the load is given to the fastest responding server

failover performance—the load is routed to available servers, avoiding servers in shutting down mode

Once the Web service server 32 has been- chosen, the SOAP router constructs a URL and sends (step 13) the SOAP message to the appropriate server 32. In the event that a response from the server is not received, SOAP router 40 updates (step 14) the local data store 37, for example with HTTP −404, and then repeats (step 15) the earlier process by performing a further lookup to select an alternative Web service server (repeat of steps 10, 11 and 12), and then resends the message (repeat of step 13). This is repeated (step 15) until either a successful response is received (step 16) or there are no further suitable servers to try (step 17). Once all the options are exhausted the client 31 is notified (step 18) through an HTTP 404 error or SOAP Fault. In most cases, a response to the SOAP message will be successfully received, and the response time, success of the request and response is stored (step 14) against the relevant entry in the local data store. The response is then forwarded (step 19) to the client 31.

In order to maintain records regarding the status of servers 32, 34, and also regarding other Monitoring servers 35, a Monitor server will repeatedly poll the other servers, either in response to the external polling mechanism from the proxy 30 or alternatively to a server-side monitor thread 41. Service availaibility checks are performed by the Monitoring servers 35 by:
attempting to request a WSDL or pinging the WSDL servers
calling a test method on the Web services and evaluating the response from the Web service servers
attempting to request monitoring information from other Monitoring servers 35

The system further comprises a Deployment Manager 42 to assist in managing the server side platform. The Deployment Manager 42 comprises a plurality of database tables, including:
Service Deployment Descriptions Table 43 (associates the various services with the actual Web servers which provide them)
WSDL Deployment Description Table 44 (associates the lists of WSDLs with the actual WSDL servers which provide them)
IMSS Deployment Description Table (information relating to the Monitoring Servers)

Conveniently, the Deployment Manager 42 further comprises a Deployment Management Function 46 which allows a service operator to update the entries of Web service applications, WSDL and IMSS descriptions according to any modifications made to the services, etc which are deployed on the servers. A web Interface provides a simple way for the operator of the platform to administer the service.

In the specific embodiment described, proxy 30 is delivered as a sofware package comprising Java classes that run on JDK 1.3 JVM and above, and supports current standards WSDL 1.1 and SOAP 1.1. A standard SDK 29 allows the application developer to program in any language but access Web services thorugh simple commands. In the embodiment, the JAX-RPC 0.9 and Microsoft SOAP Toolkits provide this functionality. Configuration file 33 holds authentication details for connecting to servers using HTTP Basic Authentication for inclusion within the SOAP messages as WSSE security credential.

The server side of the system is implemented using Web servers or J2EE components, though .Net servers and IIS could be used. In the embodiment, the servers are running on a client driven basis in the sense that they only respond to the external polling mechanism from either the proxy 30 or alternatively from a server side monitor thread 41.

Client side components, proxy 30, configuration file 33, standard SDK-29 and client 31 may be considered to be a single client module 28, communicating with the variety of different server side components (WSDL servers 34, Monitoring servers 35 and Web service servers 32) over any suitable network, which in the specific embodiment is the internet. However, the type of network is not essential to the invention, and it is understood that the servers may be either local or remote.

It is anticipated that various modifications to the invention may be made. For example, whilst a client side configuration file 33 is also provided, to point to the available Monitorng servers 35, this could alternatively be replaced by a database or an API that could allow configuration.

### APPENDIX A

### MONITORING SERVER REPORT EXAMPLES

This information can be encoded in HTML, XML and SOAP form the following example is encoded in HTML (comments shown as //)

// Addresses of monitor (Integrity Management System Servers ) IMSS -
this case JSPs but the could be XML or SOAP
IMSS/server1=http://www.erica.bt.co.uk/IMSS.jsp
IMSS/server2=http://www.erica3.bt.co.uk/IMSS.jsp
IMSS/server4=http://www.erica4.bt.co.uk/IMSS.jsp
// URLs of implementations of services
SERVICE/erica_service1/testService=http://www.erica3.bt.co.uk/
erica_service1 testService/
SERVICE/erica_service1/testService=http://www.erica1.bt.co.uk/
erica_service1 testService/
SERVICE/erica_service1/testService=http://www.erica5.bt.co.uk/
erica_service1 testService/
// WSDL of these services
WSDL/erica_service1/testService=http://www.erica1.bt.co.uk/erica
_service1 testService/
WSDL/erica_service1/testService.wsdl=http://www.erica5.bt.co.uk
/erica_service1/testService.wsdl
WSDL/erica_service1/testService.wsdl=http://www.erica3.bt.co.uk
/erica_service1/testService.wsdl
// Throttleback settings of this service
THROTTLEBACK/erica_service1/testService=5000
// Load of this service 0 = no load 10 = fully loaded
LOAD/http://www.erica1.bt.co.uk/erica_service1/testService/=10
LOAD/http://www.erica3.bt.co.uk/erica_service1/testService/=5
LOAD/http://www.erica5.bt.co.uk/erica_service1/testService/=0
// Last status check in response in milliseconds
PERFORMANCE/http://www.erica1.bt.co.uk/erica_service1/testService/=
151
PERFORMANCE/http://www.erica3.bt.co.uk/erica_service1/testService/=
204
PERFORMANCE/http://www.erica5.bt.co.uk/erica_service1/testservice/=
97
// Status of servers (hosts)
SERVER_STATUS/http:www.erica1.bt.co.uk=ACTIVE
SERVER_STATUS/http:www.erica3.bt.co.uk=ACTIVE
SERVER_STATUS/http:www.erica5.bt.co.uk=
SHUTTING_DOWN_5_MINUTES
SERVER_STATUS/http:www.erica6.bt.co.uk=SHUTDOWN
// Poll IMSS rate in seconds
HEARTBEAT_POLL_PERIOD=15

Local Store—Services records

| | | | Accessed | |
|---|---|---|---|---|
| Service | URL | Load | (Unix ms) | Response |
| /erica_service1/testService | http://www.erica5.bt.co.uk/erica_service1/testService | 5 | 002120120 | 70 |
| /erica_service1/testService | http://www.erica5.bt.co.uk/erica_service1/testService | 0 | 002120120 | 120 |
| /erica_service1/testService | http://www.erica5.bt.co.uk/erica_service1/testService | 10 | 000000000 | 0 |

Local Store—WSDL Records

| | | Accessed | |
|---|---|---|---|
| WSDL | URL | (Unix ms) | Response |
| /erica_service1/testService.wsdl | http://www.erica5.bt.co.uk/erica_service1/testService.wsdl | 002120120 | 70 |
| /erica_service1/testService.wsdl | http://www.erica1.bt.co.uk/erica_service1/testService.wsdl | 002120120 | −404 |
| /erica_service1/testService.wsdl | http://www.erica3.bt.co.uk/erica_service1/testService.wsdl | 000000000 | 0 |

Local Store—Server Status Records

| | | Accessed | |
|---|---|---|---|
| Server | URL | (Unix ms) | Response |
| http://www.erica1.bt.co.uk | ACTIVE | 002120120 | 70 |
| http://www.erica3.bt.co.uk | ACTIVE | 002120120 | 120 |
| http://www.erica5.bt.co.uk | SHUTTING_DOWN_5_MINUTES | 000000000 | 0 |
| http://www.erica6.bt.co.uk | SHUTDOWN | 0 | 0 |

Local Store—Monitoring Server Status Records

| Server | Accessed (Unix ms) | Response |
|---|---|---|
| IMSS/server1=http://www.erica1.bt.co.uk/IMSS.jsp | 002120120 | 70 |
| IMSS/server2=http://www.erica3.bt.co.uk/IMSS.jsp | 002120120 | 120 |
| IMSS/server4=http://www.erica4.bt.co.uk/IMSS.jsp | 000000000 | 0 |
| http://www.erica6.bt.co.uk | 0 | 0 |

HTTP Responses also Catered for:

| | |
|---|---|
| Status-Code = | “200”; OK |

“201”; Created
“202”; Accepted
“204”; No Content
“301”; Moved Permanently
“302”; Moved Temporarily
“304”; Not Modified
“400”; Bad Request
“401”; Unauthorized
“403”; Forbidden
“404”; Not Found
“500”; Internal Server Error
“501”; Not Implemented
“502”; Bad Gateway

“503”; Service Unavailable

1. A method of managing service requests from a first module acting as a client module, to a plurality of other modules acting as server modules, the method comprising:
an information-collating module receiving from each of the other modules an indication of the operational status of each of the other modules;
at the first module, a control intermediary receiving from the information- collating module an indication of the operational status of each of the other modules;
the control intermediary selecting one of the other modules for directing a service request to based on the indications of operational status of the other modules.

2. A method according to claim 1, in which the first module comprises a client application and the control intermediary, the method comprising
the control intermediary receiving a request for a Web service description from the client application, and selecting one of the other modules to direct the request to based on the indications of operational status of the other modules;
the control intermediary receiving the requested Web service description and substituting an identifier of the control intermediary into the description before passing the description to the client application.

3. A method according to claim 1, further comprising, the control intermediary repeating the step of selecting one of the other modules for directing a service request to, so as to identify an alternative other module, in the event that the transmission of the service request to the selected module fails.

4. A method of managing service requests from a first module acting as a client module, to a plurality of other modules acting as server modules, the first module comprising a client application and a control intermediary, the method comprising:
an information-collating module receiving from each of the other modules an indication of the operational status of each of the other modules;
the control intermediary receiving from the information-collating module an indication of the operational status of each of the other modules;
the control intermediary receiving a request for a Web service description from the client application, and selecting one of the other modules to direct the request to based on the indications of operational status of the other modules;
the control intermediary receiving the requested Web service description and substituting an identifier of the control intermediary into the description before passing the description to the client application.

5. A method according to claim 4, further comprising, the control intermediary receiving a service request from the client application, and selecting one of the other modules to direct the request to based on the indications of the operational status of the other modules.

6. A method according to claim 5, further comprising the control intermediary repeating the step of selecting one of the other modules for directing a service request to, so as to identify an alternative other module, in the event that the transmission of the service request to the selected module fails.

7. A method according to claim 1, in which the control intermediary selects the one of the other modules on the basis of the loading of the modules.

8. A method according to claim 1, in which the control intermediary periodically polls the information-collating module to obtain the indications of the operational status of the other modules.

9. A system comprising a first module acting as a client module and a plurality of other modules acting as server modules, in which the client module is arranged to send service requests to the other modules, the system further comprising:
an information-collating module arranged to receive from each of the other modules an indication of the operational status of the other modules; and
the client module comprising a control intermediary arranged to receive from the information-collating module an indication of the operational status of each of the other modules, and further arranged to select one of the other modules for directing a service request to based on the indications of operational status of the other modules.

10. A system according to claim 9, the first module further comprising a client application,
the control intermediary arranged to receive a request for a Web service description from the client application, and arranged to select one of the other modules to direct the request to based on the indications of operational status of the other modules;
the control intermediary arranged to receive the requested Web service description and substitute an identifier of the control intermediary into the description before passing the description to the client application.

11. A system according to claim 9, the control intermediary further arranged to repeat the step of selecting one of the other modules for directing a service request to, so as to identify an alternative other module, in the event that the transmission of the service request to the selected module fails.

12. A system comprising a first module acting as a client module and a plurality of other modules acting as server modules, the first module comprising a client application and a control intermediary, in which the client module is arranged to send service requests to the other modules, the system further comprising:
an information-collating module arranged to receive from each of the other modules an indication of the operational status of the other modules;
the control intermediary arranged to receive from the information-collating module an indication of the operational status of each of the other modules;
the control intermediary further arranged to receive a request for a Web service description from the client application, and to select one of the other modules for directing a service request to based on the indications of operational status of the other modules; and
the control intermediary arranged to receive the requested Web service description and substitute an identifier of the control intermediary into the description before passing the description to the client application.

13. A system according to claim 12, the control intermediary further arranged to receive a service request from the client application, and to select one of the other modules to direct the request to based on the indications of the operational status of the other modules.

14. A system according to claim 13, the control intermediary further arranged to repeat the step of selecting one of the other modules for directing a service request to, so as to identify an alternative other module, in the event that the transmission of the service request to the selected module fails.

15. A system according to claim 9, in which the control intermediary is arranged to select the one of the other modules on the basis of the loading of the modules.

16. A system according to claim 9, in which the control intermediary is further arranged to periodically poll the information-collating module to obtain the indications of the operational status of the other modules.

17. A system according to claim 9, in which the other modules are Web service servers.

18. A storage medium carrying computer readable code representing instructions for causing processors to perform the method according to claim 1 when the instructions are executed by the processors.

19. A computer program comprising instructions for causing processors to perform the method according to claim 1 when the instructions are executed by the processors.

20. A computer data signal embodied in a carrier wave and representing instructions for causing processors to perform the method according to claim 1 when the instructions are executed by the processors.

21. A storage medium carrying computer readable code representing instructions for causing processors to operate as the system according to claim 9 when the instructions are executed by the processors.

22. A computer program comprising instructions for causing processors to operate as the system according to claim 9 when the instructions are executed by the processors.

23. A computer data signal embodied in a carrier wave and representing instructions for causing processors to operate as the system according to claim 9 when the instructions are executed by the processors.
